(19) United States
(12) Patent Application Publication
(10) Pub. No.: US 2026/0001811 A1
(43) Pub. Date: Jan. 1, 2026

(54) SYSTEM AND METHOD FOR NATURAL-BASED CONSTRUCTION MATERIAL

(71) Applicant: Purdue Research Foundation, West Lafayette, IN (US)

(72) Inventors: Pablo Zavattieri, West Lafayette, IN (US); Jeffrey Youngblood, Crawfordsville, IN (US); Yu Wang, Lafayette, IN (US); Jan Olek, West Lafayette, IN (US); Maria Caterina Santagata, West Lafayette, IN (US)

(21) Appl. No.: 19/253,225

(22) Filed: Jun. 27, 2025

Related U.S. Application Data
(60) Provisional application No. 63/665,811, filed on Jun. 28, 2024.

(51) Int. Cl. C04B 14/36; C04B 14/04; C04B 18/02; C04B 18/26; C04B 30/02; C04B 103/46

(52) U.S. Cl. CPC C04B 14/361; C04B 14/048; C04B 18/027; C04B 18/26; C04B 30/02; C04B 2103/465; C04B 2201/20; C04B 2201/50

(57) ABSTRACT

This disclosure relates to compositions, materials, and systems including hygromorphic fibers that are useful in the chemical arts, such as in the manufacture of products, such as construction materials and, more particularly, to natural-based construction materials. In particular, the present disclosure relates to systems, materials, and methods for preparing certain natural-based construction materials including hygromorphic fibers configured cooperate with soil.

### RELATED APPLICATIONS

This application claims the benefit of U.S. Provisional Application No. 63/665,811, filed Jun. 28, 2024, the entire disclosure of which is incorporated herein by reference.

### TECHNICAL FIELD

The disclosure generally relates to construction materials and, more particularly, to natural-based construction materials including hygromorphic fibers.

### BACKGROUND

Earth materials are both environmentally friendly and cost-effective, making it an attractive option for sustainable building construction. However, it suffers from significant challenges, including low mechanical strength, durability issues, and shrinkage problems. Addressing these challenges is crucial for enhancing the viability and performance of earth structures. The natural world offers innovative solutions to complex problems, exemplified by the concept of self-burying seeds. These seeds utilize moisture-responsive mechanisms to autonomously embed themselves in the soil, enhancing their chances of germination and survival. Inspired by such natural mechanisms, recent advancements have led to the development of artificial seed carriers that mimic these properties to improve agricultural and environmental restoration practices.

The integration of these self-burying, self-interlocking fibers into soil structures may provide several benefits. They may enhance stability by improving resistance to shrinkage and mechanical stress, leading to more durable earth structures. Their environmental adaptability may make them suitable for various soil types and conditions, ideal for applications in reforestation, erosion control, and construction. Accordingly, there is a need for natural-based construction material that leverages biomimicry to provide a sustainable, efficient method for improving soil stability and performance, with significant potential applications in soil structure.

### SUMMARY

In one aspect, the present disclosure provides a construction material including a soil mixture comprising soil and water; and a plurality of hygromorphic fibers dispersed throughout the soil mixture. In some aspects, the hygromorphic fibers cooperate with the soil mixture to improve the durability of the construction material.

In another aspect, the present disclosure provides a construction material comprising:
greater than 80 wt % of a soil mixture, wherein the soil mixture comprises soil and water, and
about 0.1 wt % to about 20 wt % of a plurality of hygromorphic fibers, wherein the hygromorphic fibers are dispersed throughout the soil mixture;
wherein the hygromorphic fibers cooperate with the soil mixture to improve the durability of the construction material.

In yet another aspect, the present disclosure provides a method of making a formed structure. For example, the method comprises the steps of: (i) combining a plurality of hygromorphic fibers and a soil mixture comprising soil and water to provide a composition; and (ii) compacting the composition to provide a formed structure.

Additional embodiments, features, and advantages of the disclosure will be apparent from the following detailed description and through practice of the disclosure. The compounds, compositions, and methods of the present disclosure can be described as embodiments in any of the following enumerated clauses. It will be understood that any of the embodiments described herein can be used in connection with any other embodiments described herein to the extent that the embodiments do not contradict one another.

### BRIEF DESCRIPTION OF THE DRAWINGS

The detailed description particularly refers to the accompanying figures. The patent or application file contains at least one drawing executed in color. Copies of this patent or patent application publication with color drawing(s) will be provided by the Office upon request and payment of the necessary fee.

FIG. 1A shows a schematic representation of the concept of the process of the self-interlocking fiber in soil materials. FIG. 1B shows a schematic representation of the curvature formation and actuation mechanisms of hygroscopic wood fiber with respect to the hydration and drying cycle.

FIGS. 2A-2C show graphs of sample drying rate. FIG. 2A shows a graph of mass (g) versus days of drying for two hand-packed cob samples. FIG. 2B shows a graph of mass (g) versus days of drying comparing a compression packed cob sample and a hand-packed cob sample. FIG. 2C shows a graph of mass (g) versus days of drying comparing a compression packed cob sample and a hand-packed cob sample.

FIG. 3 shows images from the compression testing of hand-packed cob samples at various loading rates.

FIG. 4 shows a graph of load (N) versus displacement (mm) for cob samples at different loading rates (A: 1 mm/min, B: 2 mm/min, and C: 5 mm/min). Two samples at each loading rate are shown.

FIG. 5 shows a graph of peak strength (kPa) for cob samples at different loading rates (1 mm/min, 2 mm/min, and 5 mm/min). The peak load of 2 samples was averaged for each loading rate.

FIG. 6 shows a graph of load (N) versus displacement (mm) comparing hand-packed cob samples and compression packed cob samples. Two samples for each method are shown.

FIG. 7 shows a graph of peak strength (kPa) comparing hand-packed cob samples and compression packed cob samples. The peak load of 2 samples was averaged for each loading rate.

FIGS. 8A and 8B show Digital Image Correlation (DIC) images of a hand-packed cob sample (FIG. 8A) and a compression packed cob sample (FIG. 8B) in the compression test method.

FIG. 9A shows a graph of load (N) versus displacement (mm) for soil samples.

FIG. 9B shows a graph of peak strength (kPa) for soil samples. The peak load of 3 samples was averaged for each loading rate.

FIG. 10 shows a graph of mass (g) versus days of drying showing the drying rate of cob samples with different moisture content (A, B: 22% and C, D: 24%) and drying methods (A, C: elevated and B, D: non-elevated).

FIG. 11A shows a graph of the moisture density (compaction) curve showing dry density (lb/ft³) versus moisture content for cob samples with different moisture content. Data are shown for 2 samples a 20%, 3 samples at 22%, and 3 samples at 24%.

FIG. 11B shows graph of a theoretical moisture density (compaction) curve.

FIG. 12 shows a graph of load (N) versus displacement (mm) for cob samples at different moisture content (A: 22% and B: 24%). Three samples at each moisture content are shown.

FIG. 13 shows a graph of peak strength (kPa) for cob samples at different moisture content (22% and 24%). The peak load of 3 samples was averaged for each loading rate.

FIG. 14 shows an image of a three-point bending test configuration with a cob sample that was used in flexural strength testing.

FIGS. 15A-15C show graphs of load (N) versus displacement (mm). FIG. 15A shows a graph of load (N) versus displacement (mm) comparing large cob samples (A, 4 samples) and soil samples (B, 2 samples). FIG. 15B shows a graph of load (N) versus displacement (mm) comparing large cob samples (A, 4 samples) and small cob samples (B, 5 samples). FIG. 15C shows a graph of load (N) versus displacement (mm) of small cob samples (5 samples).

FIG. 16 shows a graph of modulus of rupture (MoR) (kPa) comparing large cob samples, small cob samples, and soil samples.

FIG. 17 shows a Digital Image Correlation (DIC) images of a cob sample in the flexural test method.

FIGS. 18A-18C show images of cob samples. FIG. 18A shows a view of a cob sample sectioned in a plane orthogonal to the longest dimension. FIG. 18B shows a side view of a cob sample.

FIG. 18C shows another side view of three cob samples.

### DETAILED DESCRIPTION

An object of the present disclosure is to use self-interlocking fibers to enhance the mechanical strength, durability, and shrinkage resistance of earth-based building and construction materials. Inspired by self-burying seeds, these fibers use hygromorphic actuation, changing shape in response to moisture levels to cooperate (e.g., embed and/or interlock) within the soil or a soil mixture. Constructed from hygroscopic materials like synthetic fibers, such as specialized polymers, or natural fibers, such as treated wood fibers, they expand and contract with moisture, embedding and interlocking to form stable structures. This biomimetic approach significantly improves soil stability and performance, offering sustainable solutions for applications in construction, reforestation, and erosion control, and promising more durable and adaptable earth structures.

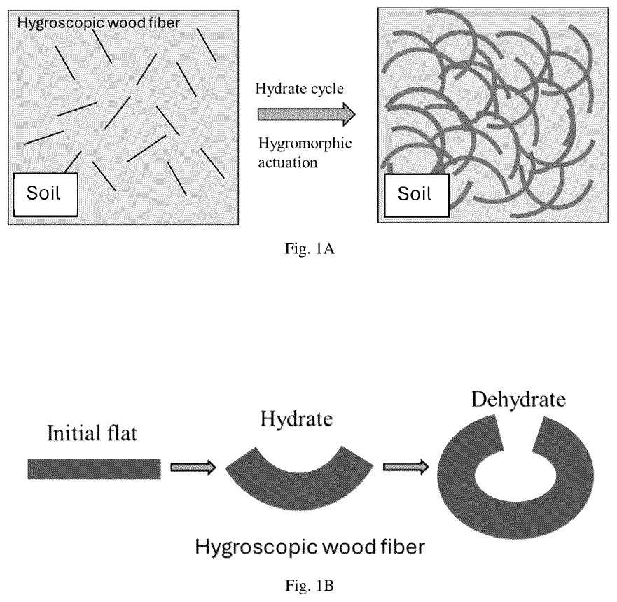

Another object of the present disclosure is to develop self-interlocking fibers designed to enhance the mechanical and durability performance, as well as the shrinkage resistance of earth structures. Constructed from hygromorphic materials, these fibers will bend in response to hydration/drying cycles (FIG. 1B). This property allows the fibers to autonomously bend and twist in the soil upon exposure to moisture. As the hygromorphic materials undergo follow-up drying after moisture exposure, the bending curvature further increases, eventually reaching a maximum curvature. During the first few days, until the earth construction material is completely dry, the hygromorphic fibers (sometimes called self-interlocking fiber) could form a stable interlocked structure.

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

### Definitions

Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

As used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used herein, the terms “including,” “containing,” and “comprising” are used in their open, non-limiting sense.

The term “about” as used herein means greater or lesser than the value or range of values stated by 10 percent, but is not intended to designate any value or range of values to only this broader definition. Each value or range of values preceded by the term “about” is also intended to encompass the embodiment of the stated absolute value or range of values. To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

As used herein, the term “cob” refers to a material including soil, water, and a fiber (e.g., straw or hygromorphic fiber).

As used herein, the term “hygromorphic” refers to a material, such as a fiber, having embedded moisture-sensitivity. For example, hygromorphic materials can undergo spatial transformation (i.e., hygromorphic actuation). Hygromorphic materials may include bio-derived materials or biological tissues. Examples of hygromorphic materials include white oak, pine cones, and wood fiber composites. White oak wood fibers, for example, can bend and expand with changes in humidity. Natural pine cones, for example, can open and close their scales based on moisture levels, allowing seeds to disperse effectively. Incorporating wood fibers into polymer matrices, for example, creates materials that can alter shape in response to moisture levels, used in construction and packaging.

As used herein, the term “hygromorphic actuation” refers to spatial transformation, such as bending, coiling (e.g., spiral or helical), drilling, expansion, and folding, in response to moisture levels. The hygromorphic material may start bending, creating bending and interlocking patterns upon being subjected to a drying and moisture cycle. The hygromorphic response may be fine-tuned by adjusting the material composition and structure. For example, combining passive materials, such as PLA (poly (lactic acid) or polylactide) or silicone, to hygromorphic materials, such as in wood-PLA composites (e.g., a bilayer structure), in varying ratios can influence the degree and direction of actuation, providing versatile design options for different applications. Moisture-induced swelling in the hygromorphic material, without affecting a passive material, such as PLA, can cause bending or twisting, enabling shape change of the composite. Treatments or 3D printing can tailor actuation behavior.

As used herein, the term “soil” may refer to an earth material including a combination of broken-down minerals, rocks, and decomposed organic matter.

### REPRESENTATIVE EMBODIMENTS

In some embodiments, the disclosure provides a construction material comprising: a soil mixture comprising soil and water; and a plurality of hygromorphic fibers. The hygromorphic fibers may be dispersed within the soil mixture and/or construction material. The hygromorphic fibers may be configured to cooperate with the soil mixture. For example, the hygromorphic fibers may cooperate with the soil mixture by interlocking with other hygromorphic fibers and/or the soil upon contacting the soil mixture. In some embodiments, the construction material consists of: a soil mixture comprising soil and water; and a plurality of hygromorphic fibers. In some embodiments, the soil mixture consists of soil and water.

In some embodiments, a first fiber of the hygromorphic fibers cooperates with the soil mixture by interlocking with a second fiber of the hygromorphic fibers, the soil, or a combination thereof. In some embodiments, a first fiber of the hygromorphic fibers cooperates with the soil mixture by embedding within the soil and interlocking with a second fiber of the hygromorphic fibers, the soil, or a combination thereof.

In some embodiments, a hygromorphic fiber cooperates with the soil mixture by interlocking with another hygromorphic fiber, the soil, or a combination thereof. In some embodiments, a hygromorphic fiber cooperates with the soil mixture by embedding within the soil and interlocking with another hygromorphic fiber, the soil, or a combination thereof.

In some embodiments, the disclosure provides a construction material comprising: a soil mixture comprising soil, an aggregate, and water; and a plurality of hygromorphic fibers. The hygromorphic fibers may be dispersed within the soil mixture and/or construction material. The hygromorphic fibers may be configured to cooperate with the soil mixture. For example, the hygromorphic fibers may cooperate with the soil mixture by interlocking with other hygromorphic fibers and/or the soil and/or the aggregate upon contacting the soil mixture. In some embodiments, the construction material consists of: a soil mixture comprising soil, an aggregate, and water; and a plurality of hygromorphic fibers. In some embodiments, the soil mixture consists of soil, an aggregate, and water.

In some embodiments, a first fiber of the hygromorphic fibers cooperates with the soil mixture by interlocking with a second fiber of the hygromorphic fibers, the soil, the aggregate, or any combination thereof. In some embodiments, a first fiber of the hygromorphic fibers cooperates with the soil mixture by embedding within the soil and/or the aggregate, and interlocking with a second fiber of the hygromorphic fibers, the soil, the aggregate, or any combination thereof.

In some embodiments, a hygromorphic fiber cooperates with the soil mixture by interlocking with another hygromorphic fiber, the soil, the aggregate, or any combination thereof. In some embodiments, a hygromorphic fiber cooperates with the soil mixture by embedding within the soil and/or the aggregate, and interlocking with another hygromorphic fiber, the soil, the aggregate, or any combination thereof.

In some embodiments, the hygromorphic fibers are dispersed within the soil mixture and/or the construction material. For example, the hygromorphic fibers may be uniformly dispersed within the soil mixture and/or the construction material.

In some embodiments, the hygromorphic fibers comprise natural fibers, synthetic fibers, or a combination thereof. In some embodiments, the hygromorphic fibers comprise natural fibers, such as wood fibers (e.g., white oak fibers or basswood fibers), straw fibers (e.g., hemp straw or natural flex straw), pine cone fibers, cellulose fibers, or wood fiber composites. The hygromorphic fibers, for example, may be a combination of one or more natural fibers. In some embodiments, the hygromorphic fibers are wood fibers, such as wood veneers. In some embodiments, the hygromorphic fibers are treated wood fibers. Treated wood fibers, for example, may have been exposed to (treated with) sodium hydroxide or sodium sulfite to remove lignin and/or hemicellulose. Treating the wood fibers may increase the flexibility of the fibers. In some embodiments, the hygromorphic fibers consist of natural fibers, synthetic fibers, or a combination thereof.

In some embodiments, the hygromorphic fibers have a density of about 400 kg/m³ to about 1000 kg/m³. In some embodiments, the hygromorphic fibers have a density of about 500 kg/m³ to about 900 kg/m³.

In some embodiments, the hygromorphic fibers have an average thickness of about 0.1 mm to about 5 mm. In some embodiments, the hygromorphic fibers have an average thickness of about 0.5 mm to about 2 mm.

In some embodiments, the hygromorphic fibers have an average length of about 0.1 cm to about 10 cm.

In some embodiments, the hygromorphic fibers comprise a bilayer structure having a first layer and a second layer. In some embodiments, the hygromorphic fibers comprise a first layer and a second layer. In some embodiments, at least one of the first layer and the second layer is a hygroscopic layer comprising a hygroscopic material, such as wood, cellulose, or hydrogel. In some embodiments, the first layer (e.g., a hygroscopic layer) comprises a hygroscopic material, such as wood, cellulose, or hydrogel, and the second layer (e.g., a passive layer) comprises a non-hygroscopic material, such as PLA (poly (lactic acid) or polylactide), silicone, or a combination thereof. Moisture-induced swelling in a hygroscopic layer may cause bending or twisting, enabling shape change.

In some embodiments, the construction material comprises about 0.1 wt % to about 20 wt % hygromorphic fibers. For example, the construction material may comprise about 0.1 wt. % to about 10 wt. %, about 0.1 wt. % to about 5 wt. %, about 1 wt. % to about 10 wt. %, or about 1 wt. % to about 5 wt. % hygromorphic fibers.

In some embodiments, the construction material comprises greater than about 60 wt. % soil mixture, greater than about 80 wt. % soil mixture, greater than about 90 wt. % soil mixture, or greater than about 95 wt. % soil mixture. In some embodiments, the construction material comprises about 60 wt % to about 99.9 wt % soil mixture. For example, the construction material may comprise about 70 wt. % to about 99.9 wt. % soil mixture, about 80 wt. % to about 99.9 wt. % soil mixture, or about 90 wt. % to about 99.9 wt. % soil mixture.

In some embodiments, the soil mixture comprises greater than about 10 wt. % soil, greater than about 20 wt. % soil, greater than about 60 wt. % soil, or greater than about 80 wt. % soil. In some embodiments, the soil mixture comprises about 20 wt % to about 95 wt % soil. For example, the soil mixture may comprise about 40 wt % to about 95 wt % soil, about 60 wt % to about 95 wt % soil, about 20 wt. % to about 90 wt. % soil, about 40 wt. % to about 90 wt. % soil, about 20 wt. % to about 80 wt. % soil, or about 40 wt. % to about 80 wt. % soil.

In some embodiments, the soil mixture comprises less than about 40 wt. % water. In some embodiments, the soil mixture comprises about 0.1 wt % to about 40 wt % water. For example, the soil mixture may comprise about 0.1 wt. % to about 10 wt. % water or about 10 wt. % to about 40 wt. % water.

In some embodiments, the construction material comprises about 5 wt % to about 75 wt % soil. For example, the construction material may comprise about 10 wt. % to about 50 wt. % soil or about 10 wt. % to about 30 wt. % soil. In some embodiments, the construction material comprises less than about 30 wt. % soil.

In some embodiments, the soil comprises organic matter, mineral matter, sand, silt, clay, parent rock, unweathered parent material, or any combination thereof. In some embodiments, the soil comprises subsoil. Subsoil, for example, may comprise sand, silt, clay, or any combination thereof. In some embodiments, the soil comprises at least about 25 wt % clay. In some embodiments, the soil comprises less than about 50 wt % sand and/or less than about 50 wt % silt. In some embodiments, the soil comprises sandy soil, clay soil, silt soil, loam soil, or any combination thereof. Sandy soil, for example, contains a higher proportion of sand and less clay. Clay soil, for example, is comparatively heavy as it has higher water retention capacity and a higher concentration of nutrients. Clay soil, for example, may comprise over 25% clay particles that are smaller in size and thus hold a large amount of water. Silt soil, for example, is a light soil with a higher fertility rate with soil particles that are larger than clay but smaller than sand. Loam soil, for example, is a mixture of sand, silt, and clay soil that combines the properties of all three types of soil to make it more fertile.

In some embodiments, the soil and/or soil mixture comprises an aggregate. In some embodiments, the aggregate is selected from the group consisting of sand (e.g., medium/fine sand or coarse sand), silt, clay (e.g., fine clay or clay), stone, gravel, and any combination thereof. In some embodiments, the aggregate consists of stone, gravel, or a combination thereof. In some embodiments, the soil and/or soil mixture comprises stone, gravel, or a combination thereof having an average particle size of about 0.25 inch to about 0.5 inch.

In some embodiments, the construction material comprises about 5 wt % to about 75 wt % aggregate. For example, the construction material may comprise about 10 wt. % to about 50 wt. % aggregate. In some embodiments, the construction material comprises less than about 50 wt. % aggregate or less than 40 wt. % aggregate.

In some embodiments, the soil mixture comprises greater than about 10 wt. % aggregate, greater than about 20 wt. % aggregate, greater than about 60 wt. % aggregate, or greater than about 80 wt. % aggregate. In some embodiments, the soil mixture comprises about 20 wt % to about 95 wt % aggregate. For example, the soil mixture may comprise about 40 wt % to about 95 wt % aggregate, about 60 wt % to about 95 wt % aggregate, about 20 wt. % to about 90 wt. % aggregate, about 40 wt. % to about 90 wt. % aggregate, about 20 wt. % to about 80 wt. % aggregate, or about 40 wt. % to about 80 wt. % aggregate.

In some embodiments, the aggregate is a lightweight aggregate. The lightweight aggregate may have an average particle size of about 0.25 inch to about 0.5 inch. The lightweight aggregate may be artificially produced and/or crushed stone. In some embodiments, the aggregate is dispersed within the soil mixture and/or the construction material. For example, the aggregate may be uniformly dispersed within the soil mixture and/or the construction material. In some embodiments, the aggregate is available from Arcosa Lightweight (Mooresville, Indiana), Ozinga, (Mokena, IL), or Buildex (Dearborn, MO).

In some embodiments, the construction material or soil mixture comprises more aggregate by weight than soil by weight. In some embodiments, the construction material or soil mixture comprises a ratio (wt./wt.) of aggregate to soil of about 1:1 to about 5:1.

In some embodiments, the construction material or soil mixture comprises about 1 wt % to about 50 wt % water. For example, the construction material or soil mixture may comprise about 10 wt. % to about 50 wt. % water or about 15 wt. % to about 30 wt % water, where the construction material has not undergone a drying process. In some embodiments, the construction material or soil mixture comprises about 20 wt % to about 30 wt % water.

In some embodiments, the construction material or soil mixture comprises less than about 10 wt % water. For example, the construction material or soil mixture may comprise less than about 5 wt. % water, where the construction material has undergone a drying process. In some embodiments, the construction material or soil mixture comprises about 0.1 wt % to about 5 wt % water.

In some embodiments, the construction material comprises a density of about 1 g/cm³ to about 2 g/cm³. For example, the construction material may comprise a density of about 1.2 g/cm³ to about 1.8 g/cm³ or about 1.5 g/cm³ to about 1.6 g/cm³. It may be advantageous to have a density below a particular value to improve handling of the construction material. In some embodiments, the construction material comprises a density of less than about 2 g/cm³, less than about 1.8 g/cm³, or less than about 1.6 g/cm³.

In some embodiments, the construction material comprises a peak strength (load) of greater than or equal to about 1200 kPa. For example, the construction material may comprise a peak strength of about 1200 kPa to about 2000 kPa.

In some embodiments, the construction material comprises a modulus of rupture of greater than or equal to about 345 kPa. For example, the construction material may comprise a modulus of rupture of about 345 kPa to about 1000 kPa.

In some embodiments, the construction material is a compacted composition. A compacted composition, for example, may be a construction material that has been subjected to a compacting operation. In some embodiments, the construction material has been subjected to a compacting operation, a drying operation, or any combination thereof. A compacting operation, for example, may include a step of forming (e.g., molding) the construction material, and/or a step of hand-packing or compression (e.g., compression hammer) packing the construction material.

In some embodiments, the construction material is a block, such as a cylinder, a cuboid, or a cube, or a wall. For example, the construction material may be used as a building material. In some embodiments, the construction material is used in a building structure, such as a wall or a building.

In some embodiments, the disclosure provides a method of making a formed structure. In some embodiments, the method comprises the steps of:
combining a plurality of hygromorphic fibers and a soil mixture comprising soil and water to provide a composition; and
compacting the composition to provide a formed structure.

In some embodiments, the step of compacting comprises forming (e.g., molding) the composition. In some embodiments, the step of compacting comprises hand-packing or compression (e.g., compression hammer) packing the composition.

In some embodiments, the composition comprises about 1 wt % to about 50 wt % water. For example, the composition may comprise about 10 wt. % to about 50 wt. % water or about 15 wt. % to about 30 wt % water. In some embodiments, the composition comprises about 20 wt % to about 30 wt % water.

In some embodiments, the method comprises a step of drying the formed structure to provide a dried structure.

In some embodiments, the dried structure comprises less than about 10 wt % water. For example, the dried structure may comprise less than about 5 wt. % water. In some embodiments, the dried structure comprises about 0.1 wt % to about 5 wt % water.

In some embodiments, the step of drying is performed at about 20° C. to about 30° C. For example, the drying may be performed at room temperature.

In some embodiments, the step of drying is performed for about 1 day to about 14 days. For example, the drying may be performed for about 6 days to about 7 days. In some embodiments, the drying is performed for at least about 4 days, at least about 5 days, at least about 6 days, or at least about 7 days.

The step of drying may be performed at a particular relative humidity (RH). In some embodiments, the step of drying is performed at about 10% RH to about 90% RH, such as about 50% RH.

In some embodiments, the formed structure and/or the dried structure comprises a peak strength (load) of greater than or equal to about 1200 kPa. For example, the formed structure and/or the dried structure may comprise a peak strength of about 1200 kPa to about 2000 kPa.

In some embodiments, the formed structure and/or the dried structure comprises a modulus of rupture of greater than or equal to about 345 kPa. For example, the formed structure and/or the dried structure may comprise a modulus of rupture of about 345 kPa to about 1000 kPa.

In some embodiments, the formed structure and/or the dried structure is a block, such as a cylinder, a cuboid, or a cube, or a wall. For example, the formed structure and/or the dried structure may be used as a construction material. In some embodiments, the formed structure and/or the dried structure is used in a building structure, such as a wall or a building.

In some embodiments, the formed structure and/or the dried structure comprises the construction material according to the present disclosure.

### EXAMPLES

The examples and preparations provided below further illustrate and exemplify particular aspects of embodiments of the disclosure. It is to be understood that the scope of the present disclosure is not limited in any way by the scope of the following examples. All ASTM, ISO, and other standard test methods cited or referred to in this disclosure are incorporated by reference in their entirety.

### Example 1

### Materials and Methods

### Materials:

Soil was natural soil obtained from Bloomington, Indiana, USA. Lightweight aggregate was an artificially produced/crushed stone-type of material (stone/gravel) with an average particle size of about 0.25-0.5 inch.

### Sample Preparation:

Cob samples were prepared using soil (<30%), lightweight aggregate (<40%), water (20-30%), and self-interlocking fiber (1-5%). More aggregate than soil was present in the samples.

Comparative soil samples were prepared using soil (70%-80%) and water (20-30%), without hygromorphic fibers.

The building blocks or walls were prepared from soils, lightweight aggregates, water, and self-interlocking fibers. Initially, the self-interlocking fibers underwent chemical washing and mechanical molding. To prepare the material, water and aggregates were first mixed with the soil, after which the self-interlocking fibers are incorporated into the mixture. Subsequently, the material was shaped and compacted for building blocks or walls.

Two fabrication methods were employed for preparing the cob and soil samples:

(1) Hand Packing: Material was manually compacted into molds.
(2) Hammer (Compression) Packing (ASTM D698-12): Material was compacted using a compaction hammer. The material was loaded into the mold in three successive layers, each constituting approximately one-third of the mold height. Each layer was compacted 25 times using a compaction hammer. This process was repeated until the mold was completely filled. Compression packing may be advantageous for increasing efficiency as it is less labor intensive, quicker, standardized, and can produce more consistent densities. The densities of the compression packed samples may be greater than hand-packed samples. In one example, the mass of compression packed sample (3142.2 g) increased by about 50 grams compared to an equal-sized hand-packed sample (3098.6 g).

After molding, all samples were cured in a controlled curing chamber at 23±1° C. and 50±5% relative humidity for seven days before testing. During this initial drying phase of the material, lasting several days until the earth construction material was fully cured, the hygromorphic materials formed a stable interlocked structure.

### Compressive Strength Testing:

Specimen Dimensions: Rectangular prism samples measuring 4″×4″×8″ were used.

Testing Equipment: An MTS universal testing machine with a maximum load capacity of 300 kN was utilized.

Loading Rates: Samples were tested at displacement-controlled loading rates of 1 mm/min, 2 mm/min, and 5 mm/min to study rate-dependent behavior. Load rate was determined based on ASTM D2166).

Testing Protocol: Load was applied uniaxially along the longitudinal axis until failure. Load and deformation were recorded continuously to derive stress-strain behavior. Digital Image Correlation (DIC) was employed to evaluate the fracture behavior of the samples during mechanical testing.

### Moisture Variation Testing (ASTM D698-12):

This standard was used to find the ideal moisture content by identifying how the dry density is affected by moisture content. Method B was utilized, which included: 4″ mold, layering in thirds, and 25 blows/layer. Samples were removed from molds, top was scraped with a straight edge, and mass of the sample (M_{g}) was determined. From this method, the net mass of moist compacted soil (M_{g}), moist density (ρₘ), dry density (ρ_{d}), and compaction curve/moisture density curve was determined.

### Flexural Strength (Modulus of Rupture) Testing:

Specimen Dimensions: Two sets of prismatic (cuboid) samples were prepared: 6″×6″×12″ and 3″×3″×12″

Testing Equipment: An MTS universal testing machine with a 10 kN capacity was used.

Testing Method: A three-point bending test configuration was adopted with a constant displacement rate of 1.2 mm/min, as shown in FIG. 14. Digital Image Correlation (DIC) was employed to evaluate the fracture behavior of the samples during mechanical testing.

### Example 2

### Dry Rate

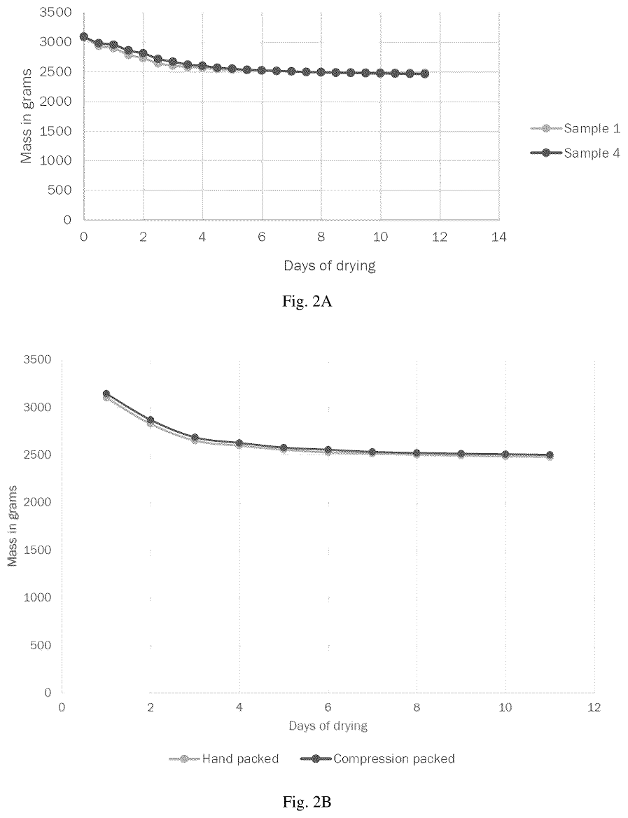

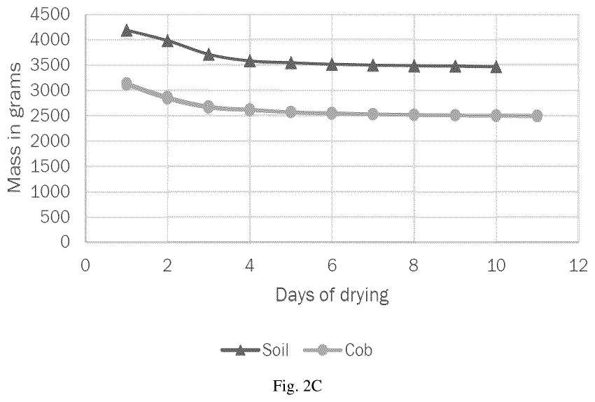

Prepared samples were kept and monitored in a 50% humidity room. The results of the drying rate are shown in FIGS. 2A-2C. For hand-packed samples, the sample was about 19.9% water (likely slightly higher) and about 18.6% of original mass lost was prior to day six, as shown in FIG. 2A. The compression packed sample remained slightly heavier than the hand-packed sample and took about a day longer for the drying curve to flatten as a result of greater density, as shown in FIG. 2B. Both compression packed and hand-packed sample drying curves flatten out after about a week.

The drying of one soil brick sample was monitored in a 50% humidity room. The soil sample moisture was about 17.4%, and the sample mass loss was about 16.05% within the first 6 days, and about 1.2% past first 6 days, as shown in FIG. 2C. Similar to the cob samples, drying completed after about 6 days for the soil sample. The soil sample carried more mass as the material was denser compared to cob samples. There was slightly less mass loss (16.05%) for the soil sample compared to cob sample mass loss (18.6%).

### Example 3

### Loading Rate Determination for Compressive Strength Testing

ASTM D2166 specifies “loaded axially at an axial strain rate between 0.5 to 2.0%/min.” With a cob brick sample of 7″, that would indicate 0.889-3.556 mm/min. In particular, a length of 177.8 mm and utilizing 2%/min would provide a rate of 3.5 mm/min.

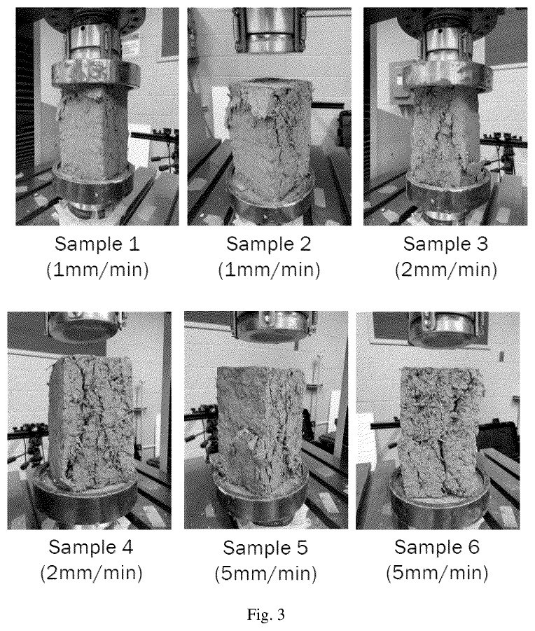

Samples were tested at displacement-controlled loading rates of 1 mm/min, 2 mm/min, and 5 mm/min to study rate-dependent behavior (FIG. 3). At 1 mm, used at Terran Robotics, results were produced in about 12 mins. At 2 mm, the samples fell within the 0.5-2.0%/min and results were produced in about 6 mins. At 5 mm, an outlier test rate, results were determined to be produced too fast in about 2 mins to see good results. The best loading rate according to ASTM D2166/D2166M-24 testing was 3.5 mm/min, and was used in further testing.

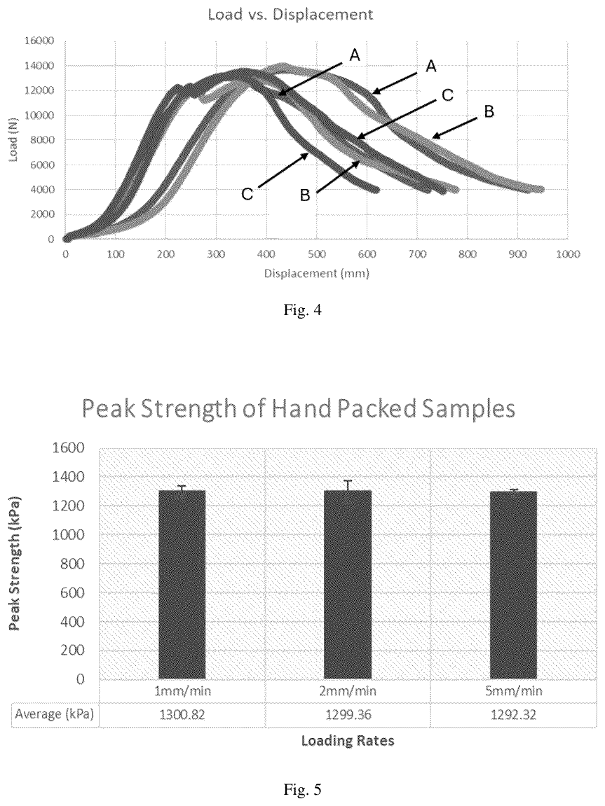

As shown in FIGS. 4 and 5, slower loading rate had a larger strain but constant peak stress. Using a faster loading rate is acceptable as strength is not affected significantly enough.

### Example 4

### Compressive Strength Testing

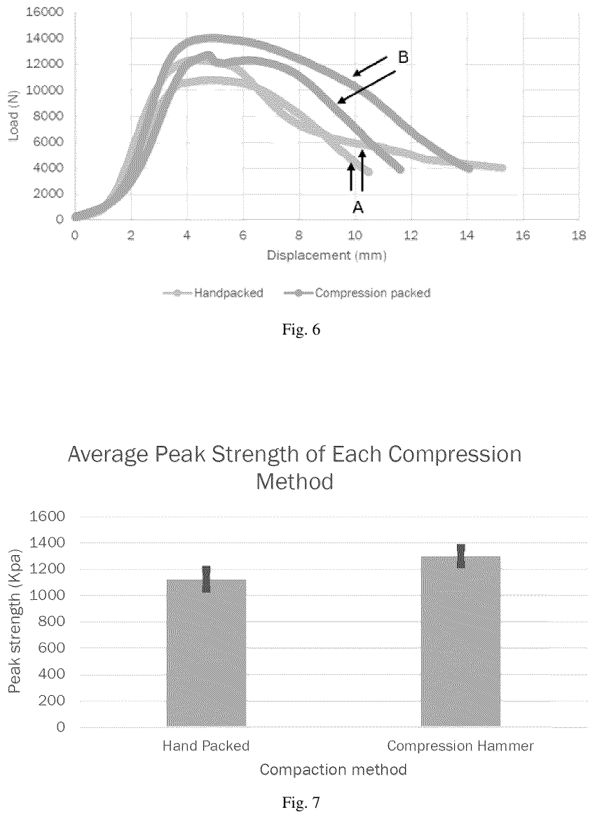

Compressive strength testing was performed in the instant example to compare compression packed cob samples and hand-packed cob samples. The compression hammer packed cob samples had higher peak strengths in compression testing than the hand-packed cob samples, as shown in FIGS. 6 and 7.

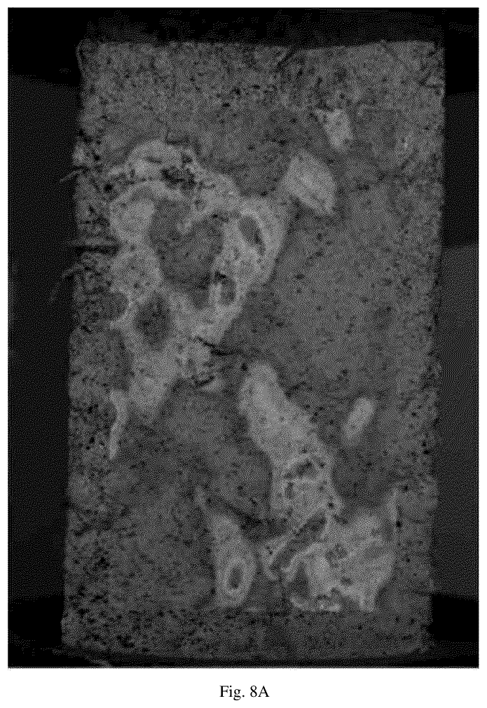

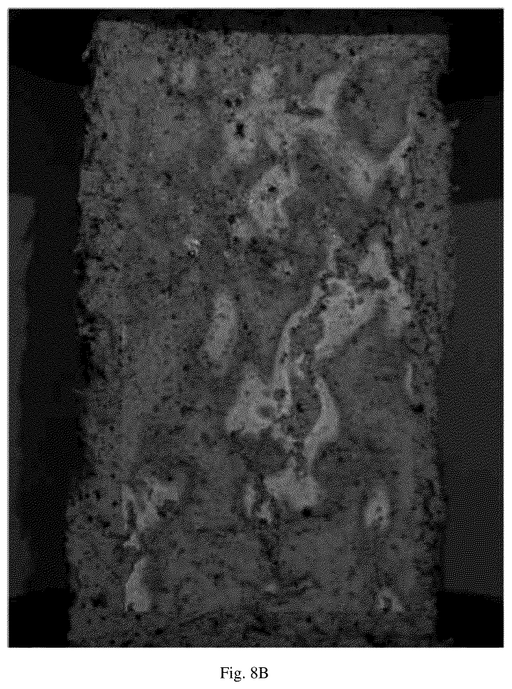

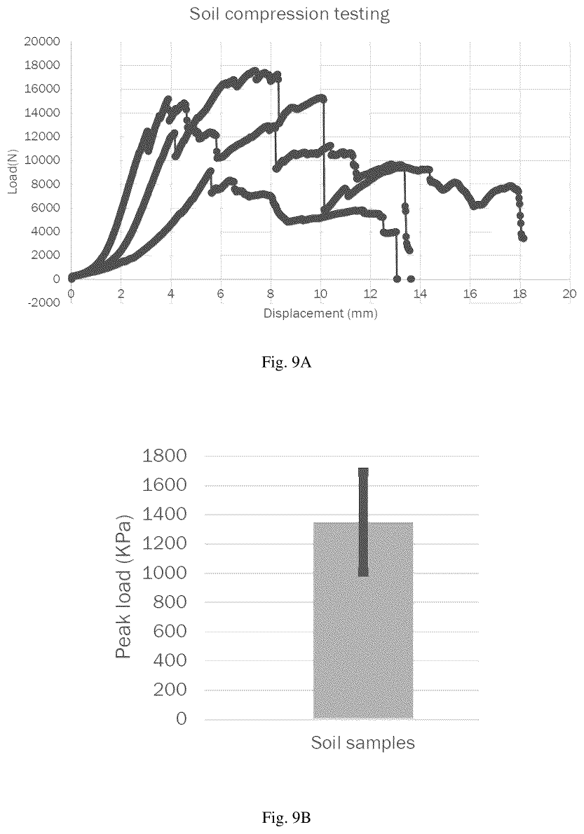

Digital Image Correlation (DIC) was performed on a hand-packed cob sample (FIG. 8A) and a compression packed cob sample (FIG. 8B) to evaluate the fracture behavior of the samples during mechanical testing. FIG. 8A shows fracturing where deformities were in the brick originally. FIG. 8B shows fracturing and potential ruptures along the layers since the compaction hammer is used every one-third in the building process.

### Example 5

### Moisture Variation Testing

ASTM D698-12 was used to find the ideal moisture content by identifying how the dry density is affected by moisture content. The moisture content of the samples was based on the initial water content in wet soil, and additional water was added to reach the indicated moisture content. As shown in FIG. 10, drying was monitored for 10 consecutive days for different drying methods and moisture content. The drying curve evened out around day 6 for each sample. The drying method for elevated samples included elevating the sample so air flow traveled under the sample. The results show little to no variance when drying method is changed (not elevated vs. elevated). Drying rate was determined to be more affected by moisture content variance than elevation while drying.

Using the ASTM standard soil compaction methods to provide cob samples with 20%, 22%, and 24% moisture content, moist density (ρₘ) was calculated using the equation:

$${ρ}_{m} = K \cdot \frac{{M}_{g}}{{V}_{m}}$$

and dry density (ρ_{d}) was calculated using the equation:

$${ρ}_{d} = \frac{{ρ}_{m}}{( 1 + \frac{ω}{100} )} ,$$

where Mg is the mass of compacted soil, Vm is the volume of the compaction mold, K is the conversion constant (0.00220462 g to lbs), and ω is the moisture content.

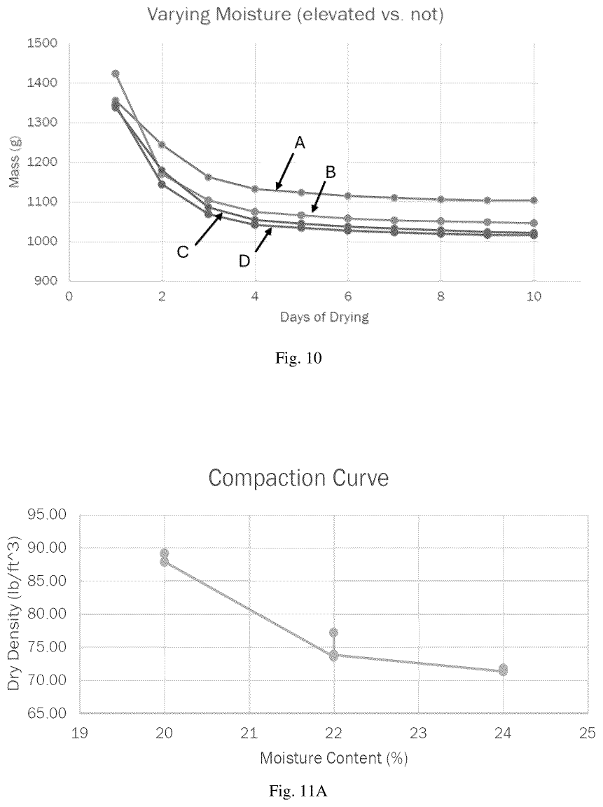

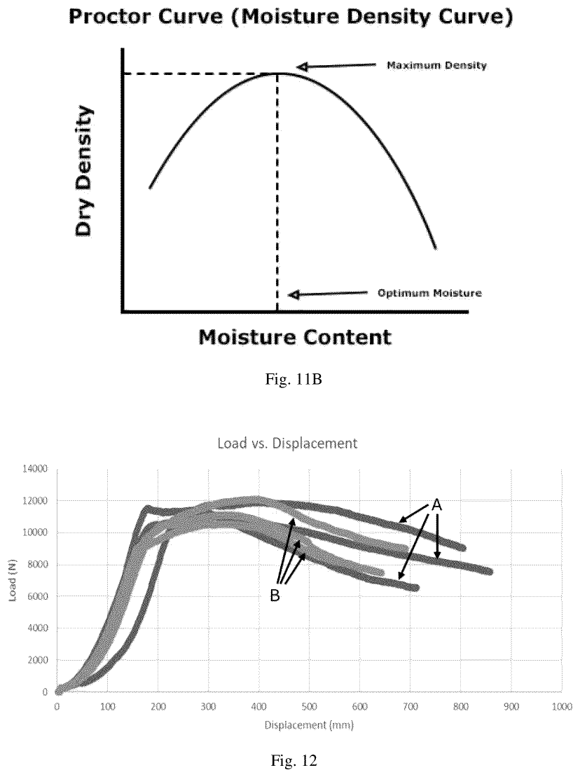

As shown in FIG. 11A, the drying density decreases as moisture content increases. The compaction curve demonstrates the ladder half of a theoretical compaction curve (FIG. 11B). Continued testing on lower moisture content samples would be required to determine if 20% moisture content is the peak of the theoretical compaction curve.

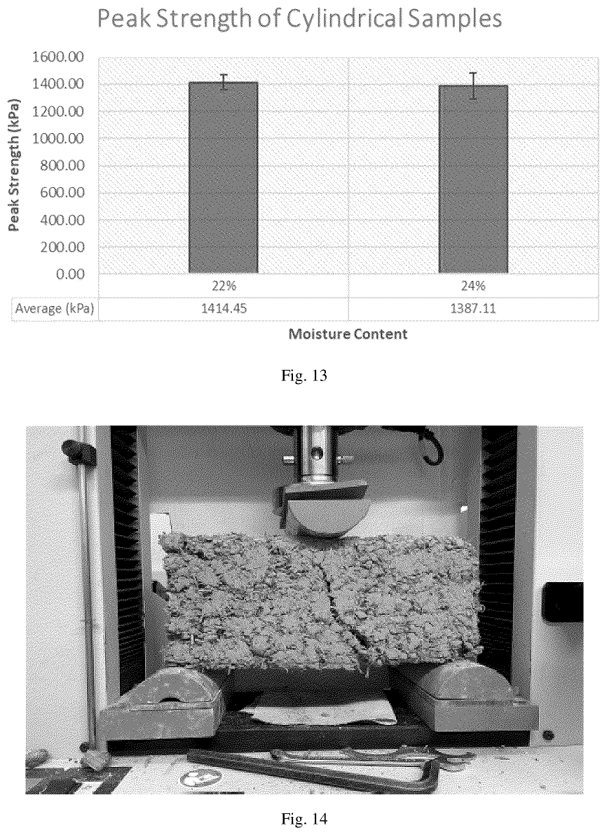

For compression testing shown in FIGS. 12 and 13, a load rate was of 2.12 mm/min was used (length of 106 mm+utilizing 2%/min). The peak load of 3 samples was averaged 3 samples of each moisture content to provide 1414.45 kPa for 22% moisture and 1387.11 kPa for 24% moisture, as shown in FIG. 13. The results show that the strength decreases with higher moisture content. Therefore, unless indicated otherwise, the samples were prepared having about 20% moisture content.

### Example 6

### Modulus of Rupture Testing

Flexural strength testing was performed to determine the modulus of rupture of cob samples. The modulus of rupture of cob structural walls (i.e., cob in walls used as braced wall panels) should be a minimum of 50 psi (345 kPA) to meet a standard. For example, the standard may be outlined in Appendix AU of the International Residential Code that refers to the regulations and guidelines for building with cob, a natural construction material.

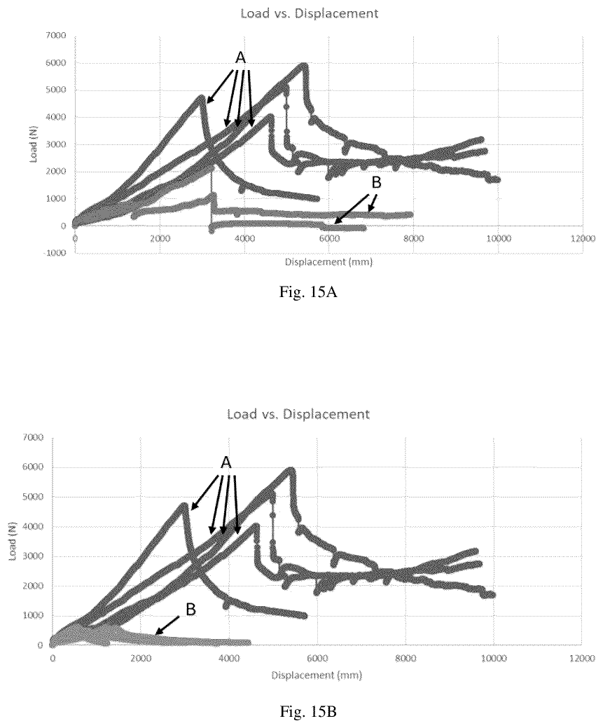

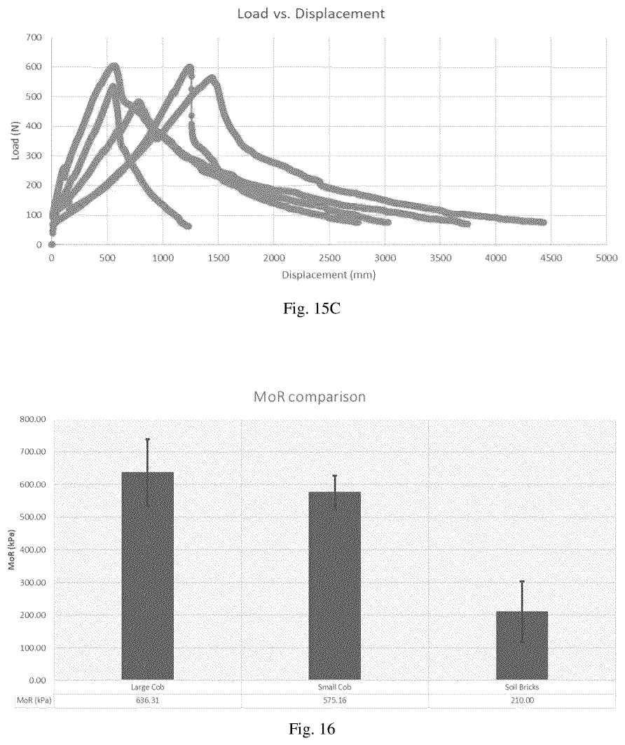

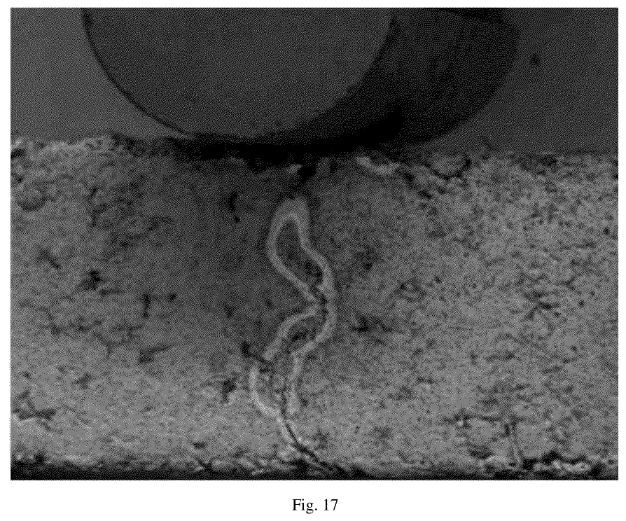

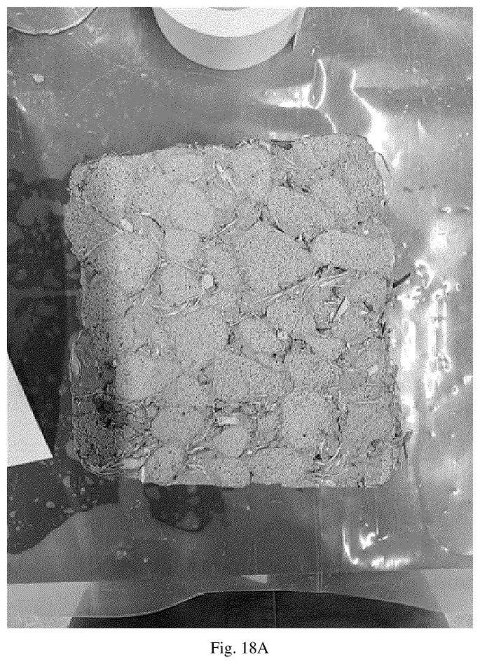

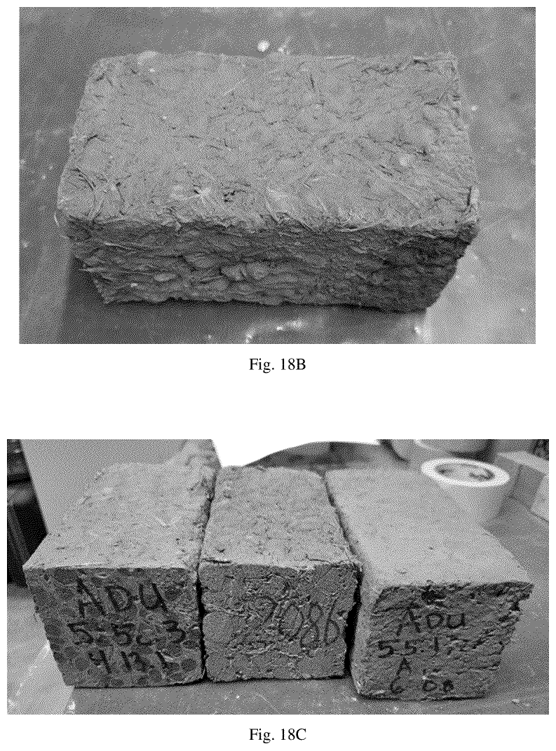

A set of 5 large cob samples (304.8 mm×152.4 mm×152.4 mm), 5 small cob samples (304.8 mm×76.2 mm×76.2 mm), and 2 soil samples (304.8 mm×152.4 mm×152.4 mm) were tested. Only two soil samples were tested as a third broke during the drying process, and therefore did not get tested. As MoR measures bond strength, soil has a comparatively smaller MoR without any fibers. Soil bricks had a MoR range of 143-276 kPa (average of 210 kPa) and cob samples had a MoR range of 498-761 kPa (average of 646 kPa for large and 575 kPa for small). Data is shown in Table 1 and illustrated in FIGS. 15A-15C and FIG. 16.

TABLE 1
Modulus of Rupture

| | |
|---|---|
| Max Load (N) | MoR (kPa) |

Large Cob: 304.8 mm × 152.4 mm × 152.4 mm (L × H × W)

| | | |
|---|---|---|
| 1 | 4003 | 517 |
| 2 | 4699 | 607 |
| 3 | 5891 | 761 |
| 4 | 5112 | 660 |
| 5 | 5067 | 655 |

Small Cob: 304.8 mm × 76.2 mm × 76.2 mm (L × H × W)

| | | |
|---|---|---|
| 1 | 482 | 498 |
| 2 | 600 | 620 |
| 3 | 563 | 582 |
| 4 | 603 | 623 |
| 5 | 534 | 552 |

Soil: 304.8 mm × 152.4 mm × 152.4 mm (L × H × W)

| | | |
|---|---|---|
| 1 | 1117 | 114 |
| 2 | 2135 | 276 |

Digital Image Correlation (DIC) was performed on a cob sample (FIG. 17) to evaluate the fracture behavior of the samples during mechanical testing. Soil brick broke with little force applied. Soil brick had large cracks before testing began. Cob brick resulted in a one winding rupture (twisting crack pattern) down the middle. For the cob samples, fracture energy is high (longer crack a greater energy distribution) and twisting is caused by fibers redirecting energy. The large cob samples demonstrated more of a shear effect rather than pure bending, indicating handling a significantly larger load. The small cob samples demonstrated bending dominated geometry.

What is claimed is:

1. A construction material comprising:
greater than 80 wt % of a soil mixture, wherein the soil mixture comprises soil and water, and
about 0.1 wt % to about 20 wt % of a plurality of hygromorphic fibers, wherein the hygromorphic fibers are dispersed throughout the soil mixture;
wherein the hygromorphic fibers cooperate with the soil mixture to improve the durability of the construction material.

2. The construction material of claim 1, wherein the hygromorphic fibers comprise natural fibers, synthetic fibers, or a combination thereof.

3. The construction material of claim 1, wherein the hygromorphic fibers comprise a first layer and a second layer, wherein at least one of the first layer and the second layer comprises a hygroscopic material.

4. The construction material of claim 1, comprising about 0.1 wt % to about 10 wt % hygromorphic fibers.

5. The construction material of claim 1, comprising about 5 wt % to about 75 wt % soil.

6. The construction material of claim 1, wherein the soil mixture comprises an aggregate selected from the group consisting of sand, silt, clay, stone, gravel, and any combination thereof.

7. The construction material of claim 6, comprising about 5 wt % to about 75 wt % aggregate.

8. The construction material of claim 6, wherein the construction material comprises more aggregate by weight than soil by weight.

9. The construction material of claim 1, comprising about 1 wt % to about 50 wt % water.

10. The construction material of claim 1, comprising about 90 wt % to about 99.9 wt % soil mixture.

11. The construction material of claim 1, having a density of about 1 g/cm³ to about 2 g/cm³.

12. The construction material of claim 1, having a peak strength of greater than or equal to about 1200 kPa.

13. The construction material of claim 1, having a modulus of rupture of greater than or equal to about 345 kPa.

14. The construction material of claim 1, wherein the construction material is a block or a wall.

15. A method of making a formed structure, the method comprising the steps of:
combining a plurality of hygromorphic fibers and a soil mixture comprising soil and water to provide a composition; and
compacting the composition to provide a formed structure.

16. The method of claim 15, further comprising a step of drying the formed structure to provide a dried structure.

17. The method of claim 16, wherein the step of drying is performed at about 20° C. to about 30° C. for about 1 day to about 14 days.

18. The method of claim 16, wherein the dried structure has a peak strength of greater than or equal to about 1200 kPa.

19. The method of claim 16, wherein the dried structure has a modulus of rupture of greater than or equal to about 345 kPa.

20. The method of claim 16, wherein the dried structure is a block or a wall.
